(19) United States
(12) Patent Application Publication
(10) Pub. No.: US 2026/0065314 A1
(43) Pub. Date: Mar. 5, 2026

(54) System for Analyzing Social Media Influencer Impact on Consumer Behavior

(71) Applicant: ELC MANAGEMENT LLC, Melville, NY (US)

(72) Inventor: Christopher Aidan, Austin, TX (US)

(21) Appl. No.: 18/819,449

(22) Filed: Aug. 29, 2024

(51) Int. Cl. G06Q 30/0242; G06N 20/00; G06Q 30/0204; G06Q 50/00

(52) U.S. Cl. CPC G06Q 30/0242; G06N 20/00; G06Q 10/40; G06Q 30/0204

(57) ABSTRACT

A computer-implemented method for generating a recommendation for displaying a new cosmetic product on a particular account comprising obtaining training data including historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products; training, based on the training data, a machine learning model to predict utilization rates of cosmetic products, resulting in a trained machine learning model; applying the trained machine learning model to parameters associated with a particular account and parameters associated with a new cosmetic product to predict a utilization rate for the new cosmetic product if displayed on the particular account; and generating a recommendation based on the predicted data for displaying the new cosmetic product on the particular account.

### FIELD OF THE INVENTION

The present invention relates generally to generating recommendations for displaying a cosmetic product on a particular account, and more specifically to utilizing machine learning to predict utilization rates of the cosmetic product if the cosmetic product is displayed on a particular account, and generating based on the predicted utilization rate.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A content creator on a social media website may post content (e.g., text, images, audio, and/or video) to a social media account associated with the content creator. Other users of the social media website may view and/or otherwise interact with the content. A content creator may post content that may influence users to buy cosmetic products.

Cosmetics companies sometimes partner with a content creator account to advertise a product users may be convinced to buy the product. The company will pay the content creator to discuss and/or display the product in a social media post. Companies may choose to partner with a content creator account because the company likes the content creator, or based solely on the number of following accounts following the content creator account. However, these may not be the most effective method of choosing a content creator account. Thus, an opportunity exists for using machine learning to generate recommendations for displaying a product on a particular account.

### SUMMARY

In one aspect, a computer-implemented method for generating a recommendation for displaying a new cosmetic product on a particular account includes obtaining, by one or more processors, training data including historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products; training, by the one or more processors and based on the training data, a machine learning model to predict utilization rates of cosmetic products based on cosmetic product parameters associated with the cosmetic products and account parameters associated with the accounts on which the cosmetic products are displayed, resulting in a trained machine learning model; applying, by the one or more processors, the trained machine learning model to particular account parameters associated with a particular account and new cosmetic product parameters associated with a new cosmetic product to predict a utilization rate for the new cosmetic product if displayed on the particular account; and generating, by the one or more processors, a recommendation based on the predicted data for displaying the new cosmetic product on the particular account.

In another aspect, a computer system for generating a recommendation for displaying a new cosmetic product on a particular account includes one or more processors; and one or more memories storing non-transitory computer-readable instructions that, when executed by the one or more processors, cause the one or more processors to obtain training data including historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products; train, based on the training data, a machine learning model to predict utilization rates of cosmetic products based on cosmetic product parameters associated with the cosmetic products and account parameters associated with the accounts on which the cosmetic products are displayed, resulting in a trained machine learning model; apply the trained machine learning model to particular account parameters associated with a particular account and new cosmetic product parameters associated with a new cosmetic product to predict a utilization rate for the new cosmetic product if displayed on the particular account; and generate a recommendation based on the predicted data for displaying the new cosmetic product on the particular account.

In still another aspect, a non-transitory computer-readable medium for generating a recommendation for displaying a new cosmetic product on a particular account includes instructions that, when executed by the one or more processors, cause the one or more processors to obtain training data including historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products; train, based on the training data, a machine learning model to predict utilization rates of cosmetic products based on cosmetic product parameters associated with the cosmetic products and account parameters associated with the accounts on which the cosmetic products are displayed, resulting in a trained machine learning model; apply the trained machine learning model to particular account parameters associated with a particular account and new cosmetic product parameters associated with a new cosmetic product to predict a utilization rate for the new cosmetic product if displayed on the particular account; and generate a recommendation based on the predicted data for displaying the new cosmetic product on the particular account.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a computing environment for generating recommendations for displaying a cosmetic product on a particular account, according to some embodiments.

FIG. 2 depicts a combined block and logic diagram for training and using machine learning models to predict a utilization rate of a cosmetic product displayed on a particular account, according to some embodiments.

FIG. 3 depicts an example social media account, according to some embodiments.

FIG. 4 depicts an example social media post, according to some embodiments.

FIG. 5 depicts a flow diagram of an exemplary computer-implemented method for generating a recommendation for displaying a cosmetic product on a particular account, according to some embodiments.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The present disclosure provides systems and methods for generating recommendations for displaying a cosmetic product on a particular social media account.

Generally, a content creator on a social media website may post (i.e., upload) content (e.g., text, images, audio, and/or video) to a social media account associated with the content creator such that the content creator's content may be viewed by others. Social media accounts may also interact with other accounts. For example, other social media accounts may follow (e.g., subscribe to) the content creator's account such that content from the content creator's account appears in the other social media account's content feed (i.e., list of content that is continuously updated). Social media accounts may also interact with posts. For example, a social media account may submit a comment about a post, reply to comments on a post, and/or like a post or comment. A content creator's account may be influential to other accounts such that following accounts may take advice from the content creator's account. One such type of advice may include what products, such as cosmetic products, to purchase. For example, a content creator may post a picture of a cosmetic product and urge others to buy it.

Because a content creator account may convince others to purchase a product, companies, such as cosmetic companies, sometimes partner with a content creator account to advertise a product so that following accounts may be convinced to buy the product. The company will pay the content creator to discuss and/or display the product in a social media post. Companies may choose to partner with a content creator account because the company likes the content creator and/or perceives the content creator as popular, which may be based on the number of following accounts following the content creator account. However, a decision to partner with a content creator account based on such reasoning may not be the most effective method of choosing a content creator account. For example, a content creator account may not be as popular as the company believes them to be, as the following accounts are inactive or fake (i.e., bot accounts). In another example the type of cosmetic product the company wants the content creator account to display may not be popular with or relevant to a demographic representing a majority of the following accounts. For example, an anti-aging cosmetic product may not be relevant to following accounts whose users are under the age of 25. Additionally, a content creator may have a history of erratic and/or improper behavior that negatively affects the content creator account's influence on the following accounts, thus negatively affecting sales of a cosmetic product discussed and/or displayed on the content creator account.

The amount of data from creator accounts and following accounts may make determining which content creator account with which to partner difficult. To solve this problem, a machine learning model may be trained to predict a utilization rate (i.e., amount of sales) of the cosmetic product when the cosmetic product is displayed on a particular account (e.g., an account associated with a particular content creator), and based on the predicted utilization rate, generate a recommendation for displaying the product on the particular account (i.e., partnering with a particular content creator). For example, the recommendation could be whether to partner with a particular content creator, a selection of a particular content creators out of a group of content creators, a selection of a particular content creator for a particular product, etc. The machine learning model may be trained on training data such as historical account parameters associated with historical accounts, historical cosmetic product parameters associated with historical cosmetic products displayed on historical accounts, and historical utilization rate data (i.e., sales data) associated with the historical cosmetics products, to predict a utilization rate for a new cosmetic product displayed on a particular content creator account. This approach increases the accuracy of utilization rate predictions and recommendations for partnering with a content creator.

One improvement offered by the present techniques is the enhancement of processing efficiency. The present techniques allow for the efficient gathering of data. By automating the prediction of a utilization rate of a product displayed on a particular account, the system reduces the time and resources required to manually track and analyze the effects of displaying a product on a particular account. This process speeds up the analysis of partnering with different content creators but ensures that partnering with a particular content creator has a positive effect on the sales of the cosmetic product. Additionally, the techniques of the present disclosure solve an internet-centric problem of social media analysis. Social media websites generate types of data particular to social media accounts and content. The techniques of the present disclosure provide for efficient analysis of social media to accurately predict the effects of a particular content creator.

### Example Computing Environment

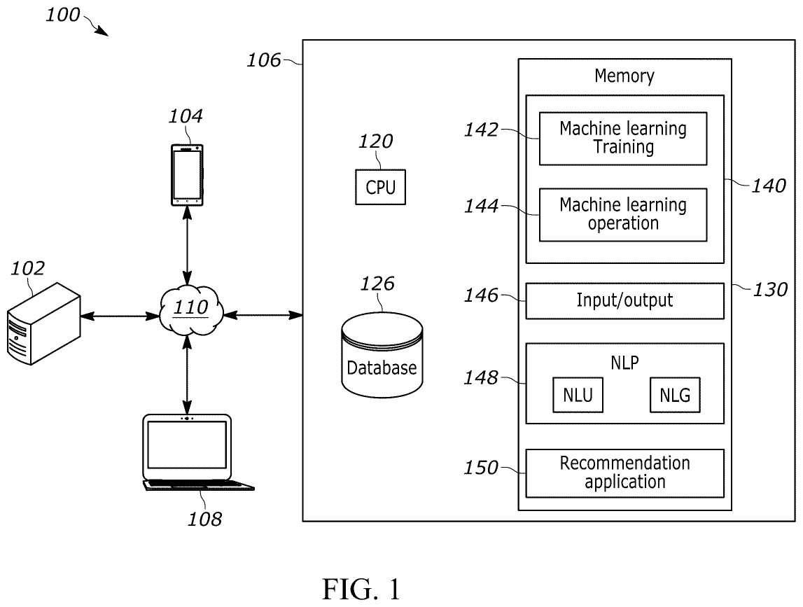

FIG. 1 illustrates an exemplary computing environment 100 associated with generating a recommendation for displaying a new cosmetic product on an account (i.e., a social media account). Although FIG. 1 depicts certain entities, components, equipment, and devices, it should be appreciated that additional or alternate entities, components, equipment, and devices are envisioned.

The environment 100 may include a social media server 102, a content creator device 104, a cosmetics company server 106, and a user device 108. The social media server 102, the content creator device 104, the cosmetics company server 106, and the user device 108 may be communicatively coupled via an electronic network 110.

As shown in FIG. 1, the computing environment 100 may include a social media server 102 associated with a social media website. The social media website may include posts from social media users, such as a content creator associated with the content creator device 104, that show and/or discuss cosmetic products. The social media server 102 may store account data that the server 106 may retrieve and use as training data (i.e., for historical account parameters). The social media server 102 may communicate with other components of the computing environment 100 via the network 110.

The computing environment 100 may also include a content creator device 104. The content creator device 104 may be any suitable device for communication, including one or more computers, mobile devices, wearables, smart watches, smart contact lenses, smart glasses, augmented reality glasses, virtual reality headsets, mixed or extended reality glasses or headsets, telephones, and/or other electronic or electrical components. The content creator device 104 may communicate with other components of the computing environment 100 via the network 110. A content creator may use the content creator device 104 to post information to a social media website, i.e., transmit data to the social media servers 102 via the network 110.

In one aspect, one or more servers 106 may perform functionalities as part of a cloud network or may otherwise communicate with other hardware or software components within one or more cloud computing environments to send, retrieve, or otherwise analyze data or information described herein. For instance, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a beauty brand) may host one or more services for predicting a utilization rate of a cosmetic product and generating recommendations for displaying the product on a particular account in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the beauty brand). Alternatively, or in addition, aspects of the public cloud may be hosted on-premise at a location owned/controlled by an enterprise generating the beauty content. The public cloud may be partitioned using virtualization and multi-tenancy techniques and may include one or more infrastructure-as-a-service (IaaS) and/or platform-as-a-service (PaaS) services.

The cosmetics company server 106 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 130 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 130 via a computer bus to execute an operating system (OS) and/or computing instructions contained therein, and/or to access other services/aspects. For example, the processors 120 may interface with the memory 130 via the computer bus to create, read, update, delete, or otherwise access or interact with the data stored in a database 126 and/or the memory 130.

The database 126 may be a relational database, such as Oracle, DB2, MySQL, a NoSQL-based database, such as MongoDB, or another suitable database. The database 126 may store data that is used to train and/or operate one or more ML models, provide augmented reality models/displays, among other things.

The memory 130 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 130 may store an operating system (OS) (e.g., Microsoft Windows, Linux, UNIX, etc.) capable of facilitating the functionalities, apps, methods, or other software as discussed herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 130) to facilitate, implement, or perform the machine-readable instructions, methods, processes, elements, or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code, or the like (e.g., via Golang, Python, C, C++, C #, Objective-C, Java, Scala, ActionScript, JavaScript, HTML, CSS, XML, etc.).

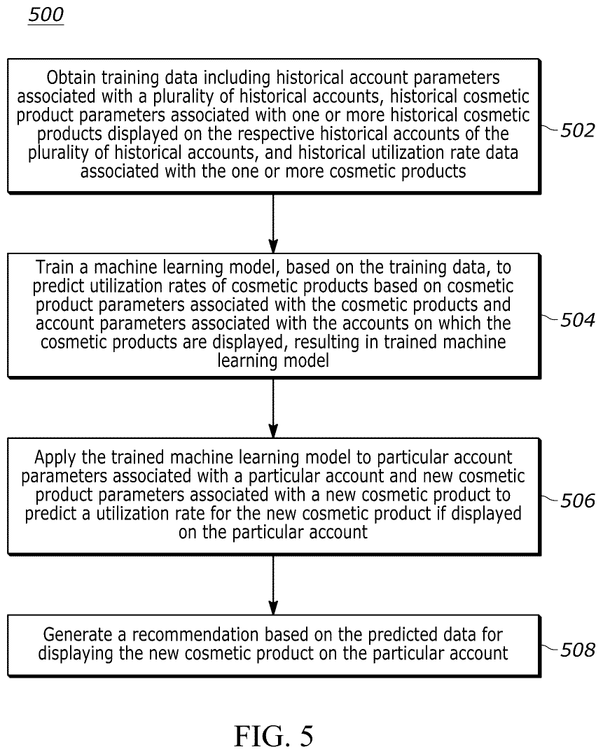

The memory 130 may store a plurality of computing modules including a machine learning module 140, an I/O module 146, a natural language processing (NLP) module 148, and a recommendation application 150. The computing modules may be implemented as respective sets of computer-executable instructions (e.g., one or more source code libraries, trained ML models such as neural networks, convolutional neural networks, etc.) as described herein. The memories may further store instructions for performing any of the steps of the method 500 described below at FIG. 5.

In one aspect, the memory 130 may include an ML module 140. The ML module 140 may include an ML training module (MLTM) 142 and/or an ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML-based algorithms may be included as a library or package executed on server(s) 106. For example, libraries may include the TensorFlow-based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function that maps outputs to inputs and may utilize the predictive function to generate ML outputs based upon data inputs. The exemplary inputs and exemplary outputs of the training data may include any of the data inputs or ML outputs described herein. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization, and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 108 (for rendering or visualizing) described herein. In one aspect, the servers 106 may include a client-server platform technology such as ASP. NET, Java J2EE, Ruby on Rails, Node.js, a web service or online API, responsible for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch-sensitive input panels, keys, buttons, lights, LEDs), which may be directly accessible via, or attached to, servers 106 or may be indirectly accessible via or attached to the user device 104. According to one aspect, a user may access the servers 106 via the user device 108 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU), and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the memory 130 may include one or more recommendation applications 150 which may be programmed to predict a utilization rate for a cosmetic product displayed on a particular account. The recommendation application 150 may receive inputs and/or requests (e.g., a particular social media account, a particular cosmetic product, a request for recommendations for displaying a particular product on a particular account, etc.) and interact with other modules stored in the memory 130 (e.g., the machine learning model 144, the natural language processing module 148, etc.) to generate recommendations to output to the user. As noted, in some embodiments, a recommendation application 150 may be configured to implement machine learning, such that server 106 “learns” to analyze, organize, and/or process data without being explicitly programmed. Machine learning may be implemented through machine learning methods and algorithms.

The computing environment 100 may include a user device 108. The user device 108 may be any suitable device for communication, including one or more computers, mobile devices, wearables, smart watches, smart contact lenses, smart glasses, augmented reality glasses, virtual reality headsets, mixed or extended reality glasses or headsets, telephones, and/or other electronic or electrical components. The user device 108 may communicate with other components of the computing environment 100 via the network 110. According to one aspect, a user may access the cosmetic company server 106 via the user device 108 to review information, make changes, input training data, initiate training via the MLTM 142, and/or perform other functions (e.g., operation of one or more trained models via the MLOM 144). The user device 108 may also be used to display information from the cosmetic company server 106.

A network 110 may comprise any suitable network or networks, including a local area network (LAN), wide area network (WAN), the Internet, or a combination thereof. For example, the network 110 may include a wireless cellular service (e.g., 4G, 5G, 6G, etc.). Generally, the network 110 enables bidirectional communication between, the social media server 102, the content creator device 104, the cosmetic company server 106, and the user device 108. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like.

Although the computing environment 100 is shown to include one social media server 102, one user device 104, one cosmetics company server 106, and one network 110, it should be understood that different numbers of social media servers 102, content creator devices 104, servers 106, user devices 108, and/or networks 110 may be utilized.

The computing environment 100 may include additional, fewer, and/or alternate components, and may be configured to perform additional, fewer, or alternate actions, including components/actions described herein. Although the beauty content generation environment 100 is shown in FIG. 1 as including one instance of various components such as social media server 102, user device 104, server 106, user device 108, network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 106 and user device 108 may be connected via a direct communication link (not shown in FIG. 1) instead of, or in addition to, via network 110.

In operation, the computing environment 100 functions to generate recommendations for displaying a new cosmetic product on a social media account associated with a content creator based on a predicted utilization rate (i.e., sales of the cosmetic product) for the new cosmetic product if it is displayed on the content creator's account. The machine learning model 144 may be trained on historical data including historical account parameters (i.e., characteristics) of social media accounts, historical cosmetic product parameters of historical cosmetic products that had previously been displayed on the social media accounts, and historical utilization rate data (i.e., sales data) associated with the historical cosmetic products. The machine learning model 144 may be trained to predict a utilization rate of a new cosmetic product if the cosmetic product were to be displayed on a particular content creator's social media account. The machine learning model 144 may generate a recommendation for displaying the new cosmetic product on the particular content creator's social media account (i.e., partnering with a particular social media influencer to promote the new cosmetic product).

### Example Training of Machine Learning Model

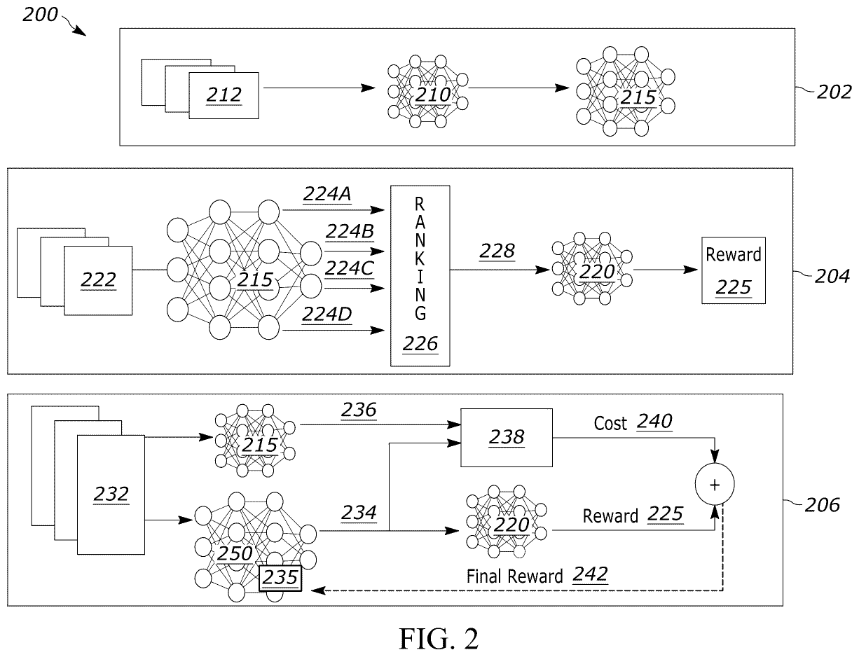

FIG. 2 depicts a combined block and logic diagram for training a machine learning model, such as machine learning model 144. The machine learning model 144 may be trained to predict a utilization rate (i.e., sales of a particular cosmetic product) as a result of displaying a cosmetic product on a social media account associated with a particular content creator, where the techniques described herein may be implemented according to some embodiments. In some embodiments, the machine learning model 144 may be trained to predict a utilization rate of a cosmetic product for a particular demographic when the cosmetic product is displayed on a social media account associated with a particular content creator. The utilization rate may then be used to generate a recommendation for displaying the cosmetic product on a particular account (i.e., partnering with a particular content creator). For example, partnering with a particular account may be recommended if the predicted utilization rate is above a threshold utilization rate. In another example, a group of accounts may be ranked by predicted utilization rate and partnering with the account with the highest predicted utilization rate, on the top two accounts, top three accounts, etc. may be recommended.

In some embodiments, the machine learning model 144 may be trained to predict a risk level associated with displaying a cosmetic product (e.g., that a utilization rate for the cosmetic product will be low, that a utilization rate for the product with regard to a particular demographic will be low, a probability that posts and/or comments by other social media accounts will include negative sentiment toward the cosmetic product and/or social media account, etc.), which may be used to generate recommendations for mitigating risk. For example, not partnering with a particular content creator and/or partnering with a different content creator may be recommended when the predicted risk level is above a threshold.

In some embodiments, the machine learning model 144 may be trained to identify parameters from text, image, video, and/or audio data. For example, the machine learning model 144 may be trained to identify cosmetic parameters such as a type of cosmetic product, a color of a cosmetic product, an ingredient of a cosmetic product, and/or other qualities of a cosmetic product.

Some blocks in FIG. 2 may represent hardware and/or software components, others may represent data structures or memory storing these data structures, registers, or state variables (e.g., data structures for representing social media accounts and/or cosmetic products), and other blocks may represent output data. Input and/or output signals may be represented by arrows labeled with corresponding signal names and/or other identifiers. The methods and systems may include one or more servers 202, 204, 206. The servers 202, 204, and 206 may be the same as server 106, or may be additional servers separate from the server 106.

The system and methods to generate and/or train one or more machine learning models 144 (e.g., via the machine learning training module 142 of the cosmetics company server 106), may consist of three steps: (1) a training step, at which stage the machine learning model may represent a cursory model for what may be later developed; (2) a reward model step where human labelers may rank numerous machine learning model outputs to evaluate the output which best mimic preferred human output, generating comparison data, and be trained with on the comparison data; and/or (3) a policy optimization step in which the reward model may further improve the machine learning model. In one aspect, step one may take place only once, while steps two and three may be iterated continuously, e.g., more comparison data is collected on the current machine learning model, which may be used to optimize/update the reward model and/or further optimize/update the policy. The outcome of this step may be the machine learning model 144 using an optimized policy.

In one aspect, the server 202 may train a machine learning model 210, which may be the machine learning model 144 of FIG. 1. The server may employ supervised learning techniques, unsupervised learning techniques, reinforcement learning techniques, etc. A training dataset 212 may be used to train the machine learning model 210 wherein each data input to the machine learning model 210 may have a known output for the machine learning model 210 to learn from. The training dataset 212 may be stored in a memory of the server 202, e.g., the memory 122 or the database 126. In one aspect, data labelers (e.g., users of the user device 108) may create the training dataset 212 inputs and appropriate outputs.

In one aspect, the training dataset 212 may include data which may be relevant to predicting a utilization rate of a new cosmetic product when the new cosmetic product is displayed on the particular account. For example, the training data 212 may include text, audio, image, and/or video data and may include historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products. The text, audio, image, and/or video data including historical account parameters and historical cosmetic product parameters may be input data with associated historical utilization rate data as output data. The machine learning model 210 may be trained to identify an association between input data including historical account parameters and historical cosmetic product parameters and output data including historical utilization rate to predict a utilization rate of a new cosmetic product when the new cosmetic product is displayed on the particular account. In some embodiments, the historical utilization rate data of the training data 212 may further include utilization rate for a particular demographic such that In some embodiments, the training data 212 may include risk level data associated with respective historical accounts as output data, such that the machine learning model 210 may be trained to identify an association between input data including historical account parameters and historical cosmetic product parameters and output data including the risk level data.

In some embodiments, the machine learning model 210 may be trained to identify parameters from image data. The training data 212 may include image data that has been broken down into features and labeled with text. For example, an image of lipstick may be labeled as “lipstick.” The features may be used as inputs for the machine learning model 210 and the labels as outputs, such that the machine learning model 210 learns an association between the features and the labels and learns to recognize images.

In some embodiments, the machine learning training module 142 updates the training data 212 as needed, e.g., to include new data. For example, the machine learning training module 142 may dynamically update the training data 212 with new historical account parameters associated with a plurality of historical accounts, new historical cosmetic product parameters associated with one or more historical cosmetic products displayed on the respective historical accounts of the plurality of historical accounts, and new historical utilization rate data associated with the one or more cosmetic products. In some embodiments, the machine learning model 210 may be retrained and/or fine-tuned using the updated training dataset 212 resulting in the fine-tuned machine learning model 215, which may be the machine learning model 144 of FIG. 1. The machine learning model 210 may be retrained and/or fine-tuned based upon the updated training data 212, or the new portions thereof, to improve (e.g., make more accurate predictions) over time. For example, the training data 212 may be updated to include actual utilization rate data for a cosmetic product, and as a result of training the machine learning model 210 on the updated training data 212 the machine learning model 210 may generate improved predictions for a utilization rate of a new cosmetic product if the product is displayed on a particular social media account. In another example, the machine learning model 210 may be retrained and/or fine-tuned to improve identification of parameters from text, image, video, and/or audio data.

### Training the Reward Model

In one aspect, training the machine learning model 250, which may be machine learning model 144, may include the server 204 training a reward model 220, which may be machine learning model 144, to provide as an output a scaler value/reward 225. The reward model 220 may be required to leverage Reinforcement Learning with Human Feedback (RLHF) in which a model (e.g., machine learning model 250) learns to produce outputs which maximize its reward 225, and in doing so may provide responses which are better aligned to input data.

Training the reward model 220 may include the server 204 providing a single input dataset 222 to the fine-tuned machine learning model 215 as an input. The input dataset 222 may be provided via an input device (e.g., a keyboard of a user device 108) via the I/O module of the server, such as I/O module 146. The input dataset 222 may be previously unknown to the fine-tuned machine learning model 215, e.g., the labelers may generate new input data, the input data 222 may include testing data stored on database 126, and/or any other suitable input data. The fine-tuned machine learning model 215 may generate multiple, different output datasets 224A, 224B, 224C, 224D to the single input dataset 222. The server 204 may output the datasets 224A, 224B, 224C, 224D via an I/O module (e.g., I/O module 146) to a user device 108, such as a display (e.g., as text responses), a speaker (e.g., as audio/voice responses), and/or any other suitable manner of output of the datasets 224A, 224B, 224C, 224D for review by the data labelers.

The data labelers may provide feedback via the server 204 on the datasets 224A, 224B, 224C, 224D when ranking 226 them from best to worst based upon the input-output data pairs. The data labelers may rank 226 the datasets 224A, 224B, 224C, 224D by labeling the associated data. The ranked input-output pairs 228 may be used to train the reward model 220. In one aspect, the server 204 may load the reward model 220 via the machine learning module (e.g., the ML module 140) and train the reward model 220 using the ranked input-output pairs 228 as input. The reward model 220 may provide as an output the scalar reward 225.

In one aspect, the scalar reward 225 may include a value numerically representing the best output dataset to an input dataset. For example, a higher scaler reward value may indicate a predicted output is more accurate, and a lower scalar reward may indicate that the predicted output is less accurate. For example, inputting the “winning” input-output pair dataset to the reward model 220 may generate a winning reward. Inputting a “losing” input-output pair dataset to the same reward model 220 may generate a losing reward. The reward model 220 and/or scalar reward 225 may be updated based upon labelers ranking 226 additional input-output pairs generated in response to additional input datasets 222.

In one example, a data labeler may provide input data 222 including an image of red lipstick to the fine-tuned machine learning model 215 trained to identify cosmetic product parameters. The input may be provided by the labeler via the user device 108 over network 110 to the server 204 running a fine-tuned machine learning model 215. The fine-tuned machine learning model 215 may provide as output data to the labeler via the user device 108: (i) “lipstick” for output 224A; (ii) “red lipstick” for output 224B; and (iii) “eyeliner” for 224C. The data labeler may rank 226, via labeling the prompt-response pairs, input-output pair 222/224B as the most preferred answer; input-output pair 222/224A as a less preferred answer; and input-output pair 222/224C as the least preferred answer. The labeler may rank 226 the input-output pair data in any suitable manner. The ranked input-output pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the fine-tuned machine learning model 215 to generate more accurate output data in response to input data, i.e., the fine-tuned machine learning model 215 may generate the response such as text to the prompt, and the reward model 220 may receive the response to generate a scalar reward 225 of how well humans perceive it. Reinforcement learning may optimize the fine-tuned model 215 with respect to the reward model 220.

### RLHF to Train the ML Model

In one aspect, the server 206 may train the machine learning model 250 (e.g., via the machine learning module 140) to generate output data 234 to a random, new and/or previously unknown input data 232. To generate the output data 234, the machine learning model 250 may use a policy 235 (e.g., algorithm) which it learns during training of the reward model 220, and in doing so may advance from the fine-tuned model 215 to the machine learning model 250. The policy 235 may represent a strategy that the machine learning model 250 learns to maximize its reward 225. As discussed herein, based upon input-output pairs, a human labeler may continuously provide feedback to assist in determining how well the machine learning model's 250 output data matches expected output data to determine rewards 225. The rewards 225 may feed back into the machine learning model 250 to evolve the policy 235. Thus, the policy 235 may adjust the parameters of the machine learning model 250 based upon the rewards 225 it receives for generating good responses. The policy 235 may update as the machine learning model 250 provides output data 234 to input data 232.

In one aspect, the output data 234 of the machine learning model 250 using the policy 235 based upon the reward 225 may be compared using a cost function 238 to the fine-tuned model 215 (which may not use a policy) output data 236 of the same input data 232. The server 206 may compute a cost 240 based upon the cost function 238 of the outputs 234, 236. The cost 240 may reduce the distance between the responses 234, 236, i.e., a statistical distance measuring how one probability distribution is different from a second, in one aspect the output data 234 of the machine learning model 250 versus the output data 236 of the fine-tuned model 215. Using the cost 240 to reduce the distance between the outputs 234, 236 may avoid a server over-optimizing the reward model 220 and deviating too drastically from the intended output. Without the cost 240, the machine learning model 250 optimizations may result in generating outputs 234 which are unreasonable but may still result in the reward model 220 outputting a high reward 225.

In one aspect, the outputs 234 of the machine learning model 250 using the current policy 235 may be passed by the server 206 to the rewards model 220, which may return the scalar reward or discount 225. The machine learning model 250 response 234 may be compared via cost function 238 to the fine-tuned model 215 response 236 by the server 206 to compute the cost 240. The server 206 may generate a final reward 242 which may include the scalar reward 425 offset and/or restricted by the cost 240. The final reward or discount 242 may be provided by the server 206 to the machine learning model 250 and may update the policy 235, which in turn may improve the functionality of the machine learning model 250.

To optimize the machine learning model 250 over time, RLHF via the human labeler feedback may continue ranking 226 output data of the machine learning model 250 versus output data of earlier/other versions of the fine-tuned machine learning model 215, i.e., providing positive or negative rewards or adjustments 225. The RLHF may allow the servers (e.g., servers 204, 206) to continue iteratively updating the reward model 220 and/or the policy 235. As a result, the machine learning model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall machine learning model 250 training, fewer and/or additional servers may be utilized and/or may provide the one or more steps of the machine learning model 250 training. In one aspect, one server may provide the entire machine learning model 250 training.

### Example Social Media Webpages

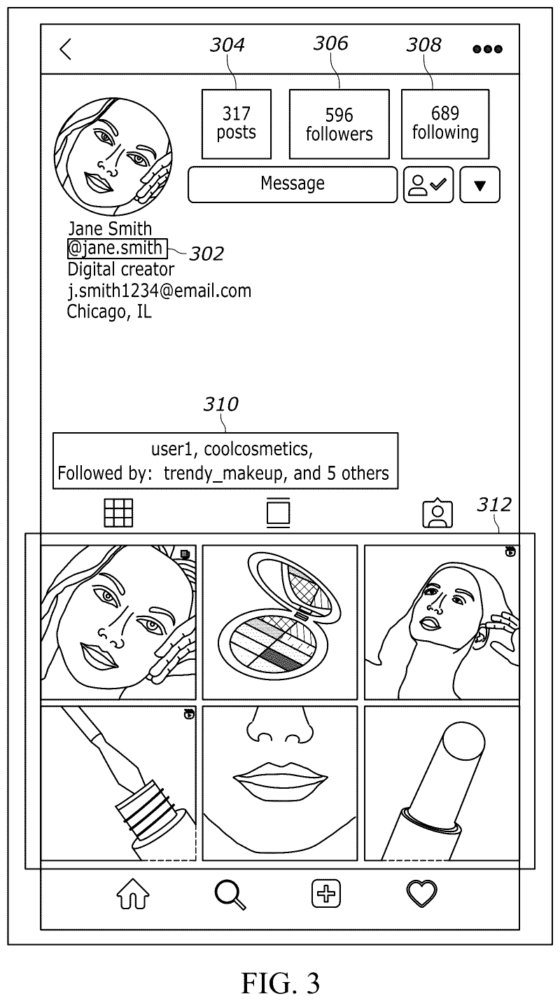

FIG. 3 depicts an example of a social media account 300 associated with a social media influencer, i.e., a user of the content creator device 104. The social media account 300 may include an account name 302, a number of posts 304, a number of follower accounts 306, a number of followed accounts 308, names of follower accounts 310, and posts 312. The social media account 300 may be hosted on a social media server, such as social media server 102, associated with a social media company.

A recommendation application 150 of a cosmetics company server, such as cosmetics company server 106 of FIG. 1, may retrieve data associated with a social media account 300 from the social media server 102. The data associated with the social media account 300 may be parameters associated with the account and used to train a machine learning model 150. The cosmetics company server 106 may communicate with a social media server 102 over the network 110 to retrieve the data. In some implementations, the recommendation application 150 of the cosmetics company server 106 may employ web scraping techniques to extract data from the social media account. The cosmetics company server 106 may fetch the account 300 from the social media server 102. The recommendation application 150 may then parse the account 300 to extract data from the account 300. In some implementations, the recommendation application 150 of the cosmetics company server 106 may additionally or alternatively use an API to retrieve data from the social media account. The API may be implemented as an endpoint accessible via a web service protocol, such as representational state transfer (REST), Simple Object Access Protocol (SOAP), JavaScript Object Notation (JSON), etc.

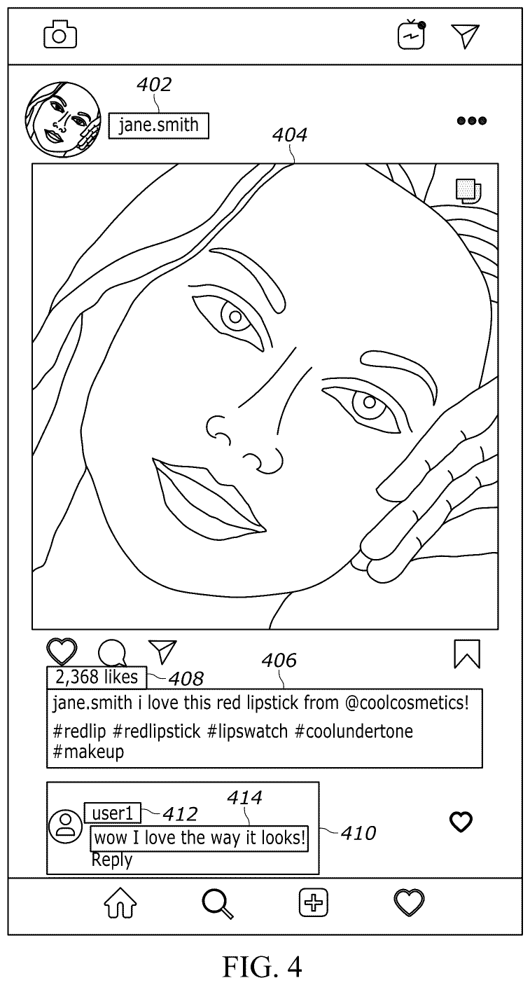

The extracted data may include the number of posts 304, the number of follower accounts 306, the number of followed accounts 308, the names of follower accounts 310, and posts 312. The number of posts 304, and the number of follower accounts 306, and the number of followed accounts 308 may be parameters associated with the social media account 300 that may be used as training data to train a recommendation machine learning model 150. In some embodiments, the names of follower accounts 310 may be used to gather additional parameters for the social media account. For example, the cosmetics company server 106 may retrieve data such as demographic data from the accounts associated respective names of follower accounts 310 to identify parameters for associated with the social media account 300. In some embodiments, the posts 312 may be text, image, audio, and/or video data. In some embodiments, parameters associated with cosmetic products and/or sentiments may be identified from the posts 312, as explained below in FIG. 4.

Although in FIG. 3 only account name 302, a number of posts 304, a number of follower accounts 306, a number of followed accounts 308, names of follower accounts 310, and posts 312 are depicted as data that may be used for identifying parameters associated with the social media account 300 to be used as training data, the social media account 300 may include other data that may be used as parameters for training data and/or may be used to identify parameters for training data. For example, the social media account 300 may include demographic information about the owner of the social media account 300 such as age, gender, nationality, etc.

The account name 302, a number of posts 304, a number of follower accounts 306, a number of followed accounts 308, names of follower accounts 310, and posts 312 may be retrieved before the machine learning model 144 has been trained, and then used to train the recommendation machine learning model 144. In some embodiments, the cosmetics company server 106 may obtain data including one or more of the account name 302, a number of posts 304, a number of follower accounts 306, a number of followed accounts 308, names of follower accounts 310, and posts 312 and extract parameters associated with the account 300 in real-time. The machine learning model 144 may use the updated parameters to predict a new utilization rate, and dynamically update the recommendation for displaying the new cosmetic product on the account.

FIG. 4 depicts an example of a social media post 400. A social media post may include an account name 402, a post image 404, post text 406, a number of likes 408, and a post comment 410 including a commenting account name 412 and comment text 414. A content creator of content creator device 104 may post a social media post 400, i.e., submit post data to the social media server 102. The social media post 400 may be hosted on a social media server, such as social media server 102, associated with a social media company. Although FIG. 4 depicts a post 400 as having a post image 404 and post text 406, the post 400 may additionally or alternatively include video and/or audio data, or may include only one of image, text, video, or audio data.

A cosmetics company server, such as cosmetics company server 106, may retrieve post data from the social media server via a recommendation application 150. The cosmetics company server 106 may employ similar techniques to extract data from the social media post as are used to extract data from the social media account page as described above, such as web scraping techniques to extract data from the social media post 400 and/or using an API to retrieve post data.

The cosmetics company server 106 may analyze the post image 404 to identify parameters associated with the image data using a machine learning model 144. In one embodiment the cosmetics company server 106 may identify that a cosmetic product used and/or depicted in the image and parameters associated with the cosmetic products. For example, the cosmetics company server 106 may identify the post image 404 depicts red lips.

The recommendation application 150 of the cosmetics company server 106 may analyze the post text 406 to identify parameters associated with the text data by using the machine learning model 144. In some embodiments, the machine learning model 144 may identify a cosmetic product and/or parameters associated with a cosmetic product. For example, the machine learning model 144 may identify the words “red” and “lipstick” as a color and type of cosmetic product, i.e., cosmetic product parameters. In some embodiments, the machine learning model 144 may interact with a natural language processing module 148 to use one or more natural language processing techniques to identify one or more sentiments from the post text 406. For example, in post text 406, the recommendation machine learning model may identify a positive sentiment indicated by the word “love.”

In some embodiments, the post 400 may additionally or alternatively include video and/or audio. In some embodiments, the machine learning model 144 may be trained to identify parameters from the video and/or audio data. In some embodiments the machine learning model 144 may interact with the natural language processing module 148 to use one or more natural language processing techniques to identify one or more sentiments from the audio data.

The post 400 may include a number of likes 408. The number of likes 408 indicates how many accounts have indicated a positive sentiment toward the post 400. The number of likes 408 may be a parameter associated with the social media account and be used to predict a utilization rate of displaying a cosmetic product on the account and/or a risk level associated with the account.

The post 400 may include a post comment 410. The post comment 410 may include a commenting account name 412 and comment text 414. The recommendation application 150 of the cosmetics company server 106 may analyze the comment text 414 using the machine learning model 144 to identify parameters associated with the text. In some embodiments, the machine learning model 144 may interact with the natural language processing module 148 to use one or more natural language processing techniques to identify one or more sentiments from the post text 406. For example, in comment text 406, the machine learning model 144 may identify a positive sentiment indicated by the word “love.” The parameters identified from the comment text 414 may be parameters associated with the social media account and be used to predict a utilization rate of displaying a cosmetic product on the account and/or a risk level associated with the account.

In some embodiments, the cosmetics company server 106 may obtain data including one or more of the account name 402, a post image 404, post text 406, a number of likes 408, and a post comment 410 and extract parameters associated with the post 400 in real-time via the recommendation application 150. The machine learning model 144 may use the updated parameters to predict a new utilization rate, and dynamically update the recommendation for displaying the new cosmetic product on the account.

### Example Method

FIG. 5 depicts a flow diagram of an exemplary computer-implemented method 500 for generating a recommendation for displaying a new cosmetic product on a particular account, according to some embodiments. One or more blocks of the method 500 may be implemented as a set of instructions stored on a computer-readable memory, such as memory 122 of FIG. 1, and executable on one or more processors. The method 500 may be implemented via one or more local or remote processors such as the processor 120, servers such as the server 106, systems such as the computing environment 100, and/or other electronic or electrical components, which may be communicatively coupled with one another.

The method 500 may include obtaining training data at block 502. The training data may include historical account parameters associated with a plurality of historical accounts, historical cosmetic product parameters associated with one or more historical cosmetic products displayed on the respective historical accounts of the plurality of historical accounts, and historical utilization rate data associated with the one or more cosmetic products. In some embodiments, the historical account parameters associated with the plurality of historical accounts may include a number of following accounts, a number of posts, a number of positive reactions, account demographics, and following account demographics.

In some embodiments, the historical account parameters associated with the plurality of historical accounts may include historical text, image, video, and/or audio data. In some embodiments, a machine learning model such as a machine learning model 144 may be trained to analyze historical text data by applying one or more natural language processing techniques to identify one or more sentiments. In some embodiments, the machine learning model 144 may be trained to analyze historical text data, and in particular, may be trained to identify one or more parameters associated with one or more cosmetic products by applying one or more natural language processing techniques to the historical text data. In some embodiments, the method 500 may include analyzing historical image, video, and/or audio data to identify parameters associated with the historical image data, the historical video data, and the historical audio data. In some embodiments, the method 500 may include analyzing the audio data to identify one or more sentiments associated with the plurality of historical accounts by applying one or more natural language processing techniques.

At block 504, the method 500 may include training a machine learning model 144, based on the training data, to predict utilization rates of cosmetic products based on parameters associated with the cosmetic products and parameters associated with the accounts on which the cosmetic products are displayed, resulting in a trained machine learning model 144.

At block 506, the method 500 may include applying the trained machine learning model 144 to account parameters associated with a particular account and new cosmetic product parameters associated with a new cosmetic product to predict a utilization rate for the new cosmetic product if displayed on the particular account. In some embodiments, the method 500 may include using the training data to train the machine learning model 144 to predict a demographic utilization rate of the new cosmetic product to be displayed on a particular account.

At block 508, the method 500 may include generating a recommendation based on the predicted data for displaying the new cosmetic product on the particular account. The predicted utilization rate may be used to generate predictions for displaying a cosmetic product on a particular account. For example, displaying a cosmetic product on a particular account may be recommended if the predicted utilization rate is above a threshold utilization rate. In another example, a group of accounts may be ranked by predicted utilization rate and displaying the cosmetic product on the account with the highest predicted utilization rate may be recommended. In embodiments where the machine learning model 144 is trained to predict a utilization rate for a particular demographic, the recommendation application 150 may recommend displaying a cosmetic product on a particular account based on the predicted utilization rate for the demographic.

In some embodiments, the method 500 may include obtaining updated parameters associated with accounts in real-time. The method 500 may include applying the trained machine learning model 144 to the updated parameters associated with the account to predict a new utilization rate and dynamically updating the recommendation for displaying the new cosmetic product on the account.

In some embodiments, the method 500 may include comparing an actual utilization rate of the new cosmetic product with the predicted utilization rate of the new cosmetic product. When the new cosmetic product is displayed on the particular account, the server 106 may receive actual utilization rate data for the new cosmetic product. The method may include refining (e.g., fine-tuning, retraining, etc.) the trained machine learning model 144 based on the comparison of the actual utilization rate data to the predicted utilization rate data.

In some embodiments, the method 500 may include obtaining parameters of historical accounts and risk levels associated with respective historical accounts and further training the machine learning model 144 using the parameters of the historical accounts and risk levels associated with the respective historical accounts to predict a risk level associated with a new account based on the parameters associated with the new account (e.g., that a utilization rate for the cosmetic product will be low, that a utilization rate for the product with regard to a particular demographic will be low, a probability that posts and/or comments by other social media accounts will include negative sentiment toward the cosmetic product and/or social media account, etc.). The method 500 may include applying the trained machine learning model 144 to a proposed account to predict a risk level associated with the proposed account and generating recommendations for mitigating the risk level associated with the proposed account. For example, not partnering with a particular content creator and/or partnering with a different content creator may be recommended when the predicted risk level is above a threshold.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated.

These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for generating recommendations for displaying a cosmetic product on a particular account, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for generating a recommendation for displaying a new cosmetic product on a particular account, the computer-implemented method comprising:
obtaining, by one or more processors, training data including historical account parameters associated with a plurality of historical accounts, historical cosmetic product parameters associated with one or more historical cosmetic products displayed on respective historical accounts of the plurality of historical accounts, and historical utilization rate data associated with the one or more historical cosmetic products, wherein obtaining historical cosmetic product parameters includes analyzing historical image data and historical video data to identify the historical cosmetic product parameters;
training, by the one or more processors and based on the training data, a machine learning model to predict utilization rates of cosmetic products based on cosmetic product parameters associated with the cosmetic products and account parameters associated with the respective historical accounts on which the cosmetic products are displayed, resulting in a trained machine learning model;
applying, by the one or more processors, the trained machine learning model to particular account parameters associated with a particular account and new cosmetic product parameters associated with a new cosmetic product to generate a predicted utilization rate for the new cosmetic product if displayed on the particular account; and
generating, by the one or more processors, a recommendation based on the predicted utilization rate for displaying the new cosmetic product on the particular account.

2. The computer-implemented method of claim 1, further comprising:
comparing, by the one or more processors, an actual utilization rate of the new cosmetic product with the predicted utilization rate of the new cosmetic product; and
refining, by the one or more processors, the trained machine learning model based on the comparing.

3. The computer-implemented method of claim 1, wherein the historical account parameters include a number of following accounts, a number of posts, a number of positive reactions, account demographics, and following account demographics.

4. The computer-implemented method of claim 3, wherein the historical account parameters include historical text data and wherein training the machine learning model further comprises:
analyzing, by the one or more processors, the historical text data, by applying one or more natural language processing techniques to the historical text data, to identify one or more sentiments.

5. The computer-implemented method of claim 1, wherein the historical account parameters include historical text data and wherein training the machine learning model further comprises:
analyzing, by the one or more processors, the historical text data, by applying one or more natural language processing techniques to the historical text data, to identify one or more parameters associated with one or more cosmetic products.

6. The computer-implemented method of claim 1, wherein the historical account parameters include historical image data associated with the plurality of historical accounts, historical video data associated with the plurality of historical accounts, and historical audio data associated with the plurality of historical accounts, and further comprising:
analyzing, by the one or more processors, the historical image data and historical video data to identify parameters associated with the historical image data, the historical video data, and the historical audio data, wherein the parameters include the cosmetic product parameters.

7. The computer-implemented method of claim 1, wherein training data includes audio data associated with the plurality of historical accounts and further comprising:
analyzing the audio data, by applying one or more natural language processing techniques to the audio data, to identify one or more sentiments associated with the plurality of historical accounts.

8. The computer-implemented method of claim 5, further comprising:
obtaining, by the one or more processors, historical account parameters and risk levels associated with respective historical accounts;
wherein training the machine learning model further comprises training the machine learning model using historical account parameters and risk levels to predict a new risk level associated with a new account based on the parameters associated with the new account;
applying, by the one or more processors, the trained machine learning model to a proposed account to predict a proposed account risk level associated with the proposed account; and
generating, by the one or more processors, recommendations for mitigating the proposed account risk level.

9. The computer-implemented method of claim 1, further comprising:
obtaining, by the one or more processors, updated parameters associated with accounts in real-time;
applying, by the one or more processors, the trained machine learning model to the updated parameters associated with the accounts to predict a new utilization rate; and
dynamically, by the one or more processors, updating the recommendation for displaying the new cosmetic product on the accounts.

10. The computer-implemented method of claim 1, wherein the historical utilization rate data includes user demographic data and further comprising:
training, by the one or more processors and based on the training data, the machine learning model to predict a demographic utilization rate of the new cosmetic product to be displayed on a particular account.

11. A computer system for generating a recommendation for displaying a new cosmetic product on a particular account, the system comprising:
one or more processors; and
one or more memories storing non-transitory computer-readable instructions that, when executed by the one or more processors, cause the one or more processors to:
obtain training data including historical account parameters associated with a plurality of historical accounts, historical cosmetic product parameters associated with one or more historical cosmetic products displayed on respective historical accounts of the plurality of historical accounts, and historical utilization rate data associated with the one or more historical cosmetic products, wherein obtaining historical cosmetic product parameters includes analyzing historical image data and historical video data to identify the historical cosmetic product parameters;
train, based on the training data, a machine learning model to predict utilization rates of cosmetic products based on cosmetic product parameters associated with the cosmetic products and account parameters associated with the respective historical accounts on which the cosmetic products are displayed, resulting in a trained machine learning model;
apply the trained machine learning model to particular account parameters associated with a particular account and new cosmetic product parameters associated with a new cosmetic product to generate a predicted utilization rate for the new cosmetic product if displayed on the particular account; and
generate a recommendation based on the predicted utilization rate for displaying the new cosmetic product on the particular account.

12. The computer system of claim 11, wherein the non-transitory computer-readable instructions, when executed by the one or more processors, further cause the one or more processors to:
compare an actual utilization rate of the new cosmetic product with the predicted utilization rate of the new cosmetic product; and
refine the trained machine learning model based on the comparing.

13. The computer system of claim 11, wherein the historical account parameters include a number of following accounts, a number of posts, a number of positive reactions, account demographics, and following account demographics.

14. The computer system of claim 13, wherein the historical account parameters include historical text data, and wherein the non-transitory computer-readable instructions, when executed by the one or more processors, further cause the one or more processors to analyze the historical text data, by applying one or more natural language processing techniques to the historical text data, to identify one or more sentiments.

15. The computer system of claim 11, wherein the historical account parameters includes historical image data associated with the plurality of historical accounts, historical video data associated with the plurality of historical accounts, and historical audio data associated with the plurality of historical accounts, and wherein the non-transitory computer-readable instructions, when executed by the one or more processors, further cause the one or more processors to analyze the historical image data and historical video data to identify parameters associated with the historical image data, the historical video data, and the historical audio data, wherein the parameters include cosmetic product parameters.

16. The computer system of claim 11, wherein training data includes audio data associated with the plurality of historical accounts and wherein the non-transitory computer-readable instructions, when executed by the one or more processors, further cause the one or more processors to analyze the audio data, by applying one or more natural language processing techniques to the audio data, to identify one or more sentiments associated with the plurality of historical accounts.

17. The computer system of claim 15, wherein the non-transitory computer-readable instructions, when executed by the one or more processors, further cause the one or more processors to:
obtain historical account parameters of historical accounts and historical risk levels associated with respective historical accounts;
wherein training the machine learning model further comprises training the machine learning model using historical account parameters and historical risk levels to predict a new account risk level associated with a new account based on the parameters associated with the new account;
apply the trained machine learning model to a proposed account to predict a proposed account risk level associated with the proposed account; and
generate recommendations for mitigating the proposed account risk level.

18. The computer system of claim 11, wherein the non-transitory computer-readable instructions, when executed by the one or more processors, further cause the one or more processors to:
obtain updated parameters associated with accounts in real-time;
apply the trained machine learning model to the updated parameters associated with the accounts to predict a new utilization rate; and
dynamically update the recommendation for displaying the new cosmetic product on the accounts.

19. The computer system of claim 11, wherein the historical utilization rate data includes user demographic data and wherein the non-transitory computer-readable instructions, when executed by the one or more processors, further cause the one or more processors to:
train, based on the training data, the machine learning model to predict a demographic utilization rate of the new cosmetic product to be displayed on a particular account.

20. A non-transitory computer-readable medium for generating a recommendation for displaying a new cosmetic product on a particular account comprising instructions that, when executed by one or more processors, cause the one or more processors to:
obtain training data including historical account parameters associated with a plurality of historical accounts, historical cosmetic product parameters associated with one or more historical cosmetic products displayed on [[the ]]respective historical accounts of the plurality of historical accounts, and historical utilization rate data associated with the one or more historical cosmetic products, wherein obtaining historical cosmetic product parameters includes analyzing historical image data and historical video data to identify the historical cosmetic product parameters;
train, based on the training data, a machine learning model to predict utilization rates of cosmetic products based on cosmetic product parameters associated with the cosmetic products and account parameters associated with the respective historical accounts on which the cosmetic products are displayed, resulting in a trained machine learning model;
apply the trained machine learning model to particular account parameters associated with a particular account and new cosmetic product parameters associated with a new cosmetic product to generate a predicted utilization rate for the new cosmetic product if displayed on the particular account; and
generate a recommendation based on the predicted utilization rate for displaying the new cosmetic product on the particular account.
